(19) United States
(12) Patent Application Publication
(10) Pub. No.: US 2002/0194540 A1
(43) Pub. Date: Dec. 19, 2002

(54) Method and system for non-intrusive dynamic memory mapping

(76) Inventors: Hugo Cheung, Tucson, AZ (US); Terence Chiu, Tucson, AZ (US); Lu Yuan, Tucson, AZ (US)

Correspondence Address: W. Daniel Swayze III, Texas Instruments, 7839 Churchill Way, MS 3999, P.O. Box 655474, Dallas, TX, 75265, US

(21) Appl. No.: 10/017,179

(22) Filed: Dec. 14, 2001

Related U.S. Application Data
(60) Provisional application No. 60/289,040, filed on May 4, 2001.

(51) Int. Cl. H04B 1/74

(52) U.S. Cl. 714/34

(57) ABSTRACT

The present invention is directed towards a method and system for implementing breakpoints in a processor system for debugging purposes. A separate memory space containing a breakpoint service routine is used and made available to the processor. When a breakpoint request is received, the main memory is switched out in favor of the separate memory space with the breakpoint service routine. The breakpoint service routine is then ran from the separate memory space. Upon the completion of the breakpoint service routine, control of the processor is switched back to the code in the main memory space.

### CROSS REFERENCE TO RELATED APPLICATION

This application claims priority from U.S. Provisional Patent Application serial No. 60/289,040, filed May 4, 2001.

### FIELD OF INVENTION

The present invention relates to memory schemes in processors and more specifically to a system and method for dynamically mapping memory.

### BACKGROUND OF THE INVENTION

Microcontrollers are used in a variety of applications, such as in appliances, computer peripherals, environmental control, instrumentation, aerospace, and a plethora of other areas in which a controller for specific functions is needed, but in which a full-function computer would be too large or power intensive to use. These microcontrollers may be self-contained products, containing a processor with memory, input and output means, timers, interrupt controller, etc., and the code that is to be executed by the processor. The code may be in a programmable memory (such as EPROM, erasable programmable read-only memory) such that the code may be easily programmed into the system. The code may also be contained in a flash memory (such as EEPROM, electrically erasable programmable read-only memory) such that the code may be modified during the testing process. Embedded controllers are similar to microcontrollers and, in some contexts, the terms are used interchangeably. Generally speaking, however, embedded controllers are not self-contained, e.g., an embedded controller may have an external memory.

Microcontrollers use computer programs to direct operations. A computer program is a set of instructions (“code”) that is used to direct the operations of a processor or computer system. Those who write code are generally called “programmers.”

When a programmer writes code to solve a particular problem, the programmer may follow a predetermined routine. For example, a programmer may start by determining, in broad terms, the steps that should be undertaken to solve the particular problem. Thereafter, the programmer may program the code needed to carry out the various steps. After the coding is finished, the program is tested to ensure the proper operation of the program in a variety of conditions. The process of testing is often termed “debugging.”

There are several different manners in which a computer program can be debugged. One method involves the use of breakpoints at various locations in a program. A breakpoint pauses or stops the execution of a program at the point at which the breakpoint is located. Once the execution of the program has stopped, values stored at certain locations (e.g., memory locations and register locations) can be determined. If the value stored in a particular memory location differs from the expected value, then the program may not be operating as intended and the code may need to be re-programmed. The use of breakpoints may also enable the values stored at a particular location to be changed to determine the effect a particular value has on the operation of the program.

Once the examination of the processor and memory is completed, the execution of the program may be resumed from the point at which it was stopped, with the processor in the same state it was before the breakpoint was asserted (with the exception of any changed memory locations, if desired). Through the use of one or more breakpoints, one can readily determine if a program is operating in the intended manner.

Breakpoints are handled by a breakpoint monitor code (also known as a “breakpoint service routine”). When a breakpoint is encountered, control of the processor is turned over to the breakpoint monitor code. The breakpoint monitor code contains the logic which enables a person testing the code to view the contents of certain locations, as detailed above.

It can be relatively easy to test software in a traditional “desktop” or “workstation” computer system. The code of the software is readily accessible to programmers and those who test the programs, using the traditional keyboard/monitor/mouse interface. There are also a number of pre-existing utilities that can be used to help debug a program. Many of those utilities contain breakpoint monitor code. However, such an interface may not be readily available in the context of microcontrollers, which may not have a keyboard, monitor, or mouse. In order to adequately test the code in a microcontroller, it is desirable to test the code in the microcontroller as it will be used.

There are several methods commonly used to generate a breakpoint. Breakpoint generation in a microcontroller may be accomplished using a firmware method of breakpoint generation. In the firmware method, existing lines of code are replaced by an instruction directing the program to the breakpoint routine. For example, in a system with 16-bit addressing, the format of a 3-byte instruction may include an instruction followed by 2-bytes (to indicate the destination for a memory move, for example) such as the following format:

| | |
|---|---|
| A1: | Opcode |
| A2: | Operand 1 |
| A3: | Operand 2 |

The above instruction could be replaced by the following 3-byte instruction:

| | |
|---|---|
| A1: | JMP |
| A2: | Addr1 |
| A3: | Addr2 |

The JMP (jump) instruction directs the operation of the code to the breakpoint routine that starts at the 16-bit address indicated by Addr1 and Addr2.

Because of various limitations to the firmware method of implementing breakpoints, hardware implementations of breakpoints have been developed. One such hardware implementation utilizes the Joint Test Action Group/Built-in Debug Module (JTAG/BDM) method. The JTAG developed a standard for testing circuitry that was sanctioned by the Institute for Electrical and Electronic Engineers (IEEE) as IEEE Standard 1149.1: Test Access Port and Boundary-Scan Architecture.

Each IEEE 1149.1 compliant device uses the boundary scan feature, which allows each functional pin of the IC to be controlled and observed through the IEEE 1149.1 interface. IEEE 1149.1 allows an IC, a board, or a system to be controlled or monitored via a standard 4-wire interface, through the use of the boundary scan feature.

In addition to the IEEE 1149.1 interface and the boundary-scan architecture, there are other test/debug interfaces that can be implemented. Among these interfaces is the Built-in Debug Module (BDM). The BDM allows a hardware controller located within the BDM to take over control flow. Thus, the JTAG/BDM method is non-intrusive, in that no code need be modified in order to implement a breakpoint. However, the JTAG/BDM method also suffers from various limitations, several of which are detailed in the Texas Instruments document Design Tradeoffs When Implementing IEEE 1149.1.

One additional problem that exists with both the firmware method and the JTAG method is the implementation of the breakpoint service routine. When a breakpoint interrupt is set, the control of the microcontroller is transferred to the breakpoint monitor code. The breakpoint monitor code allows the user to, e.g., inspect or modify various memory locations and register values. The monitor code also controls the format in which the various values are displayed.

However, in the prior art, a breakpoint service routine must be located with the application code in the same memory space. With reference to FIG. 1, an exemplary memory layout of the prior art is presented. FIG. 1 shows memory 100 containing memory space 102 and memory space 104. Memory space 102 contains the code for the controller while memory space 104 contains the breakpoint interrupt service routine code. As can be seen from FIG. 1, memory space 104 shares the same memory as memory space 102. Thus, the code in memory space 104 is limited in size because it is not desirable to interfere with the amount of memory available in memory space 102. Furthermore, modifications to the code in memory space 102 affects the entire memory 100 which must be modified in order to make such a change. This location leads to several consequences, as detailed below.

The development of a microcontroller typically involves various stages. First, the microcontoller must be designed. This step includes the design of both hardware and software. After the design is finalized, it must be developed then tested to ensure proper operation of the microcontroller. Once the microcontroller (both hardware and software) is fully developed and tested, it is made available for purchase. Typically, the developer of a microcontroller will not want any intellectual property, such as computer programs, located on the microcontroller to be available for inspection by outsiders. As discussed above, for testing purposes, the software of a microcontroller may contain a breakpoint service routine. This breakpoint service routine may allow unwanted access to the software located on the microcontroller. Therefore, the breakpoint service routine is typically removed or otherwise disabled to prevent access to the breakpoint service routine in a finalized microcontroller. Ideally, the final code in the microcontroller is the code that was approved during the testing phase. In theory, the removal or disabling of the breakpoint service routine will not lead to adverse consequences, as the microcontroller code is not be related to the breakpoint service routine code. However, there may be unforeseen instances in which the microcontroller code is inadvertently dependent on the breakpoint service routine code. In that case, the removal or disabling of the breakpoint service routine code may adversely effect the microcontroller code. One possible scenario may involve an error in the microcontroller which does not render the microcontroller unusable, but leads the microcontroller to report erroneous values. The defective microcontroller would then perform functions based on erroneous data, possibly leading to unwanted situations, such as erroneous readings on meters leading to the overcharging of customers, or inaccurate readings on temperature controller leading to unnecessary cooling or heating.

In addition, the placement of the breakpoint service routine in the same memory space as the microcontroller code may lead to a reduction in the available memory space for the user application code. Furthermore, the location of the code results in less flexibility. The mere sharing of the memory space necessitates the modification of the microcontroller code when the breakpoint code is removed or disabled. For example, in a transition from a power-off state to a power-on state, it may be necessary to initialize the breakpoint monitor code such that it will be operable when a breakpoint is encountered. However, the result is that the microcontroller code never experiences a power-on transition, only the breakpoint monitor code does. Thus, when the breakpoint monitor code is removed or disabled from the microcontroller, the microcontroller has not been completely tested.

Therefore, there is a need for a breakpoint implementation that does not suffer from the various problems described above.

### SUMMARY OF THE INVENTION

The present invention addresses many of the shortcomings of the prior art through the use of a dynamic memory mapping scheme. In accordance with an exemplary embodiment of the present invention, a dynamic memory mapping scheme uses a separate memory space to store a breakpoint service routine. When a breakpoint is asserted, the memory space is seamlessly switched such that a memory space containing a breakpoint service routine becomes the active memory space.

Thus, several advantages become apparent. For example, one can make changes to the controller code without having to make changes to breakpoint service routine code. Similarly, if the breakpoint service code must be changed, one can make changes without affecting the controller code. Furthermore, once the controller code is finalized, the controller code in the primary memory space need not be modified in any way: the final code will be identical to the code that was tested.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a memory scheme of the prior art;

FIG. 2 illustrates a memory scheme of an embodiment of the present invention;

FIG. 3 illustrates an exemplary connection between the memory scheme of the present invention and a processor;

FIG. 4 is a flow chart illustrating steps in the operation of an embodiment of the present invention; and

FIG. 5 is a flow chart illustrating further details of the operation of an embodiment of the present invention.

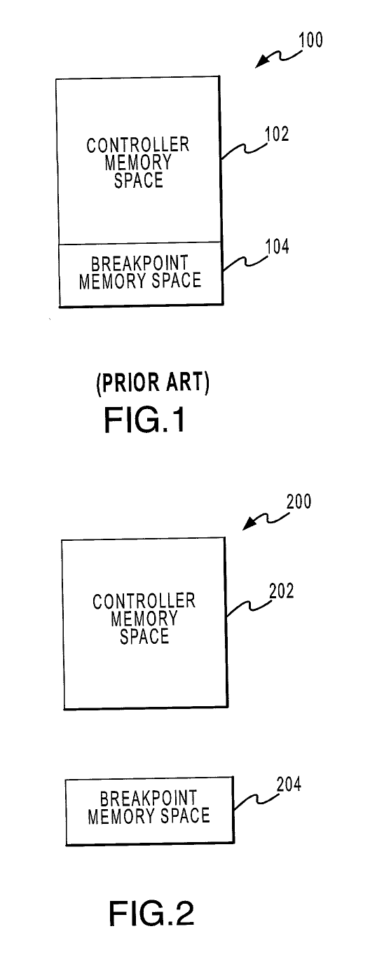

### DETAILED DESCRIPTION

The present invention may be described herein in terms of various functional components and various processing steps. It should be appreciated that such functional components may be realized by any number of hardware or structural components configured to perform the specified functions. For example, while the invention is described in the context of a microcontroller with a Harvard Architecture microcontroller, it should be understood that the present invention is also operable with microcontrollers of other architectures. In addition, the present invention is not limited to microcontrollers, as the present invention may be generally used with many types of processors. Such general applications that may be appreciated by those skilled in the art in light of the present disclosure are not described in detail herein. However, for purposes of illustration only, exemplary embodiments of the present invention will be described herein in connection with microcontrollers. Further, it should be noted that while various components may be suitably coupled or connected to other components within exemplary circuits, such connections and couplings can be realized by direct connection between components, or by connection through other components and devices located therebetween.

In accordance with an exemplary embodiment of the present invention, breakpoint monitor code is placed in a separate memory space from the microcontroller code. The separate memory space may be in the form of an internal ROM, where the monitoring and debugging code resides. When a breakpoint interrupt service request (“BPIRQ”), which is generated by a variety of different methods, is detected, a dynamic memory map controller (“DMMap”) selects this memory space and reads the code in that memory space in lieu of the code in the main memory space. Program control flow (including the handling of interrupts) is thus relinquished to code located in the separate memory space. Registers including, but not limited to, the program status word register (“PSW”) and the program counter (“PC”), are stored in a stack and the debugging process begins executing the BPIRQ routines. At the end of the BPIRQ routine, a control release bit (“CRB”) is set to inform DMMap that control flow is released. The subroutine then executes a return (“RETI”) operation and application code execution resumes as usual.

With reference to FIG. 2, an exemplary memory scheme of the present invention is shown. Memory 200 contains two separate and independent memory areas, memory space 202, which contains the code for the controller, and memory space 204, which contains the code for the breakpoint interrupt service routine. Changes to the code in memory space 202 does not result in any change to the code in memory space 204. Likewise, changes to code in memory space 204 does not affect code in memory space 202. In addition, memory space 202 is not as limited in size as that of the prior art because the sharing of code space is not present.

Memory space 204 may be a different type of memory than memory space 202. For example, memory space 204 may be a read-only memory (ROM). Therefore, a ROM containing a breakpoint interrupt service routine code may be used in a variety of different controllers merely by placing the ROM in the controller. An erasable ROM or a flash ROM may also be used, for ease in changing the breakpoint interrupt service routine.

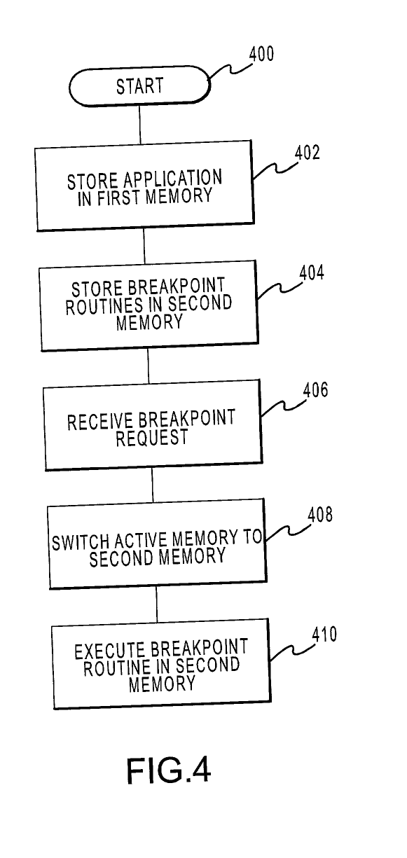

The operation of a microcontroller containing an exemplary embodiment of the present invention will now be described in greater detail. With reference to FIG. 4, the application code is stored in a first memory space (step 402) and the breakpoint service routine code is stored in the second memory space (step 404). With the controller operating the application code, the controller receives a breakpoint request (step 406). Then the active memory is switched (step 408) such that memory accesses are to the second memory space and the controller runs the code located in the second memory space (step 410), which contains the breakpoint service routine code.

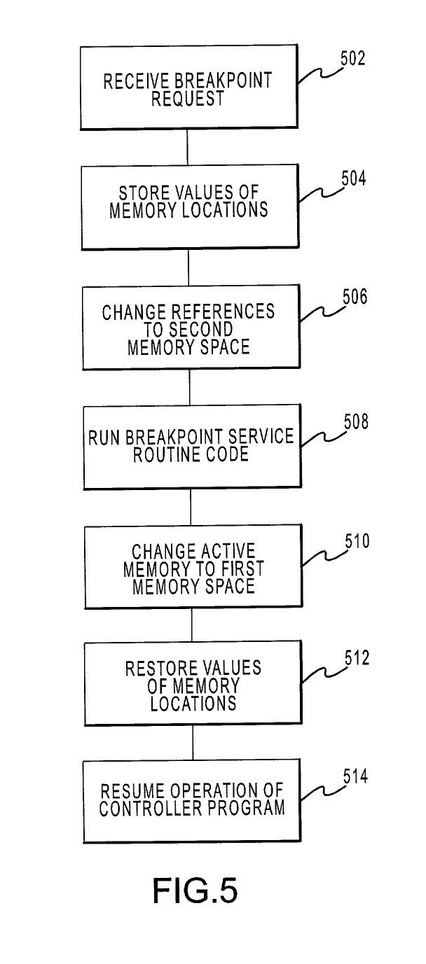

With reference to FIG. 5, the operation of an exemplary embodiment will be described in further detail. When a breakpoint interrupt request is asserted and received by the controller (step 502), by one of a variety of available methods, several memory locations, including the PSW and the PC, are PUSHed onto a memory stack (step 504). A memory decoding means is activated which changes memory references to memory space 204 instead of memory space 202 (step 506). The breakpoint service routine code performs the memory content inspection, modifications, and other tasks typically performed by a breakpoint service routine (step 508). Upon the completion of the breakpoint service routine, the return opcode (RETI) deactivates the memory decoding means such that memory space 202 is the active space (step 510); POPs the PSW and the PC from the memory stack (step 512) and the microcontroller continues operation from the point of the assertion of the break (step 514).

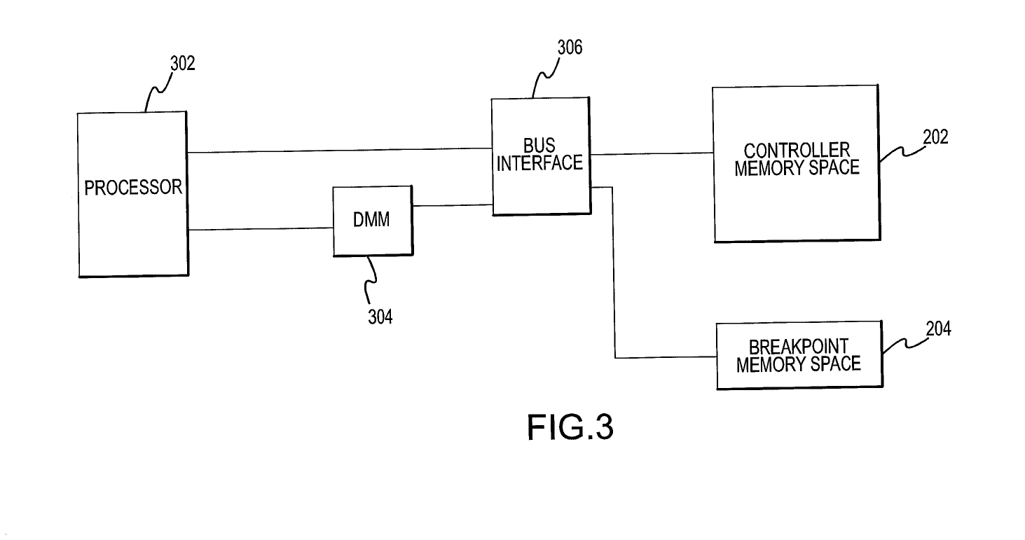

An illustrative embodiment of hardware used to accomplish the memory switching is illustrated in FIG. 3. A processor 302 is coupled to a hardware dynamic memory mapping controller 304. Both processor 302 and dynamic memory mapping controller 304 are coupled to a bus interface 306. Bus interface 306 is coupled to memory space 202 and memory space 204.

Dynamic memory mapping controller 304 is configured to receive breakpoint interrupt request information from processor 302 such that dynamic memory mapping controller 304 can react to the breakpoint request. Dynamic memory mapping controller 304 is configured to then perform the memory switching for processor 302 such that processor 302 is only able to access one of either memory space 202 or memory space 204. When the breakpoint service routine is active, processor 302 is only able to access memory space 204; when the breakpoint service routine is not active, processor 302 is only able to access memory space 202. Thus, the two memory spaces 202 and 204 remain independent of each other and a change to a program in one memory space has no effect on the program in the other memory space.

While the JTAG/BDM method uses hardware to debug the microcontroller, the methods in accordance with various exemplary embodiments of the present invention may use a software or firmware breakpoint service routine to perform that task. Using a software or firmware routine rather than hardware routine means that the breakpoint service routine is more easily modified by those who are testing the microcontroller. With a hardware breakpoint service routine, if a tester decides to develop an improvement to the breakpoint service routine, the tester must modify the hardware design. In contrast, a tester using an exemplary scheme of the present invention can merely re-code the breakpoint service routine to achieve the desired result, leading to a great improvement in the development time of a microcontroller.

Once an interrupt is detected, the memory address space, which contains the controller code, is switched with the breakpoint code, which then takes over control of the controller. Memory references by the breakpoint service routine code are references to memory space 204.

In addition, many advantages can be realized by placing the breakpoint service routine code on a ROM. Because the silicon area of a ROM has a large amount of overhead, increasing the size of the ROM does not result in a proportional increase in the size of the silicon area occupied by the ROM. For example, a 100% increase in the size of a ROM may result in only a 20-30% increase in the area occupied by the ROM. Furthermore, the modification of a ROM, for example, to modify the breakpoint service routine to inspect other locations or perform other modifications, is an easy task with the use of flash memory or other types of erasable ROMs.

Compared to the firmware method, which combines the breakpoint service routine in the same memory space as the application code, an exemplary dynamic memory mapping scheme locates the breakpoint service routine in a separate area of memory, such as a separate ROM. The problem of intrusiveness in the firmware method, where the application code being tested is not the same as the application code that will be released, is thus alleviated.

Compared to the JTAG/BDM method, which requires additional hardware to implement the breakpoints, including additional pins, an exemplary dynamic memory mapping scheme is efficient because the existing hardware of a microcontroller can be leveraged, without the additional costs of a BDM controller.

In addition, an exemplary dynamic memory mapping scheme allows the use of a variety of different formats. In the JTAG/BDM method, a tester is limited to the method pre-programmed in the JTAG/BDM controller, because of the difficulty in reprogramming the JTAG/BDM controller. In contrast, because the ROM storing the breakpoint service routine could be modified through the use of IC mask changes, such a change can easily be made in an embodiment of the present invention.

The above description presents exemplary modes contemplated in carrying out the invention. The techniques described above, however, are susceptible to modifications and alternate constructions from the embodiments shown above. Other variations and modifications of the present invention will be apparent to those of ordinary skill in the art, and it is the intent of the appended claims that such variations and modifications be covered. For example, the memory controller may also be implemented using software or firmware, instead of a hardware controller. In addition the order of the described steps is not necessarily material, unless otherwise noted. Furthermore, various steps can be altered, added, or deleted to the embodiments described and illustrated in the application without a deleterious effect on the present invention.

Consequently, it is not the intention to limit the invention to the particular embodiments disclosed. On the contrary, the invention is intended to cover all modifications and alternate constructions falling within the scope of the invention, as expressed in the following claims when read in light of the description and drawings. No element described in this specification is necessary for the practice of the invention unless expressly described herein as “essential” or “required.”

1. A method for implementing a breakpoint debugging scheme comprising:
storing application code in a first memory;
storing a breakpoint service routine in a separate second memory;
encountering a breakpoint request;
switching the active memory from said first memory to said second memory; and
executing said breakpoint service routine stored in said second memory.

2. The method of claim 1 further comprising:
switching the active memory from said second memory to said first memory upon completion of said breakpoint service routine.

3. The method of claim 2 further comprising:
storing status information in a memory stack prior to said switching the active memory from said first memory to said second memory; and
reading said status information from the memory stack upon completion of said breakpoint service routine.

4. The method of claim 1 wherein said second memory is not accessible when said first memory is active.

5. The method of claim 4 further wherein said first memory is not accessible when said second memory is active.

6. A method for implementing a memory scheme comprising:
receiving a breakpoint request;
storing status information in a memory stack prior to said switching the active memory from a first memory to a second memory;
changing memory references from said first memory to said second memory; and
operating a program stored in said second memory.

7. The method of claim 6 further comprising:
restoring memory references from said second memory to said first memory; and
reading said status information from the memory stack upon completion of said breakpoint service routine.

8. The method of claim 6 wherein
said second memory contains a breakpoint service routine.

9. The method of claim 6 further comprising:
resuming operation of a program stored in said first memory.

10. A system for non-intrusive dynamic memory mapping, said system comprising:
a processor;
a first memory for storage of application code;
a second memory for storage of a breakpoint service routine, said second memory configured separate from said first memory; and
a controller coupled between said processor, said first memory, and said second memory, wherein,
said controller is configured to select one of said first memory and said second memory based on the status of said processor.

11. The system of claim 10 wherein said status of said processor includes information regarding the breakpoint status of said processor.

12. The system of claim 10 further comprising a bus interface coupled to said first memory, said second memory, said processor, and said controller.

13. The system of claim 12 wherein said bus interface is configured to send and receive data to and from said first memory and said second memory; and
further wherein said bus interface is further configured to send and receive data to and from said processor based on instructions received from said controller.

14. The system of claim 12 wherein said bus interface is configured to access only one of said first memory and said second memory based on signals provided by said controller.

15. The system of claim 10 wherein said controller is configured to select said second memory when a breakpoint interrupt service request is made.

16. The system of claim 10 wherein said second memory is a read-only memory.
